(19) United States
(12) Patent Application Publication
(10) Pub. No.: US 2015/0017322 A1
(43) Pub. Date: Jan. 15, 2015

(54) SULPHATES OF USE AS ELECTRODE MATERIALS

(71) Applicants: CENTRE NATIONAL DE LA RECHERCHE SCIENTIFQUE, Paris (FR); UNIVERSITE DE PICARDIE JULES VERNE, Amiens (FR)

(72) Inventors: Marine Reynaud, Tain L'Hermitage (FR); Mohamed Ati, Amiens (FR); Jean-Noel Choland, Amiens (FR); Jean-Marie Tarascon, Mennecy (FR)

(73) Assignees: CENTRE NATIONAL DE LA RECHERCHE SCIENTIFIQUE, Paris, (FR); UNIVERSITE DE PICARDIE JULES VERNE, Amiens (FR)

(21) Appl. No.: 14/378,699

(22) PCT Filed: Feb. 27, 2013
(86) PCT No.: PCT/FR2013/050397

§ 371 Date: Aug. 14, 2014

(30) Foreign Application Priority Data
Feb. 29, 2012 (FR) FR 12 51854
Feb. 27, 2013 (FR) PCT/FR2013/050397

(51) Int. Cl. H01M 4/136; H01M 4/58; H01M 4/62; H01M 4/1397

(52) U.S. Cl. CPC H01M 4/136; H01M 4/1397; H01M 4/5825; H01M 4/625; H01M 4/622; H01M 2004/028
USPC 427/126.6; 205/59; 252/182.1; 252/506

(57) ABSTRACT

The invention relates to an electrode material.

Said material is characterized in that it contains, as positive electrode active material, at least one sulphate of iron in the +II oxidation state and of alkali metal corresponding to the formula (Na₁₋ₐLi_{b})ₓFe_{y}(SO₄), (I) in which the subscripts a, b, x, y and z are chosen so as to ensure the electroneutrality of the compound, with 0≦a≦1, 0≦b≦1, 1≦x≦3, 1≦y≦2, 1≦z≦3, and 2≦(2z−x)/y<3 so that at least one portion of the iron is in the +II oxidation state, with the exclusion of the compound Li₂Fe²(SO₄)₃.

It is of use in particular as a positive electrode material in an alkali metal ion battery.

The present invention relates to an electrode material containing a sulphate as active material, and also to a process for the production thereof.

Lithium batteries are known that use an insertion compound as a basis for the operation of the positive electrode, such as LiₓCoO₂ (0.4≦x≦1) which is used pure or in solid solution with nickel, manganese and/or aluminium. The main obstacles to the generalization of this type of electrochemistry are the rarity of cobalt and the excessively positive potential of the transitional metal oxides, with, as consequences, safety problems for the battery.

LiₓT^{M}ₘZ_{y}P₁₋ₛSi₈O₄ compounds (“oxyanions”) are also known in which T^{M} is chosen from Fe, Mn and Co, and Z represents one or more elements that have a valence between 1 and 5 and that may be substituted into the sites of the transition metals or of the lithium. These compounds exchange only the lithium and have only a very low electronic and ionic conductivity. These handicaps may be overcome by the use of very fine particles (such as nanoparticles) and by the deposition of a carbon coating by pyrolysis of organic compounds. The drawbacks associated with the use of nanoparticles are a low tap density which results in a loss of specific energy, and this problem is further aggravated by the deposition of carbon. Furthermore, the deposition of carbon takes place at high temperature, under reducing conditions. In practice, it is difficult to use transition elements other than Fe^{II} and the elements Co^{II} and Ni^{II} being readily reduced to the metallic state. The same applies for Fe^{III}, Mn^{III}, Cr^{III}, V^{III} and V^{IV} which are advantageous dopants for increasing the ionic or electronic conductivity.

Other compounds have been proposed, especially compounds corresponding to the general formula AₐM_{b}(SO₄)_{c}Z_{d} in which A represents at least one alkali metal, Z represents at least one element chosen from F and OH, and M represents at least one divalent or trivalent metal cation. L. Sebastian et al., [J. Mater. Chem., 2002, 374-377] describe the preparation of LiMgSO₄F via a ceramic route, and also the crystallographic structure of said compound which is isotypic of the structure of tavorite LiFePO₄OH. The authors mention the high ionic conduction of this compound, and suggest that the compounds LiMSO₄F in which M is Fe, Co or Ni, which would be isostructural, appear to be significant for the redox insertion/extraction of lithium involving M^{II}/M^{III} oxidation states. The authors also specify that the preparation of the compounds of Fe, Ni or Co via a ceramic route is in progress, but no subsequent publication regarding these compounds has been made.

Moreover, patent application US-2005/0163699 describes the preparation, via a ceramic route, of the aforementioned AₐM_{b}(SO₄)_{c}Z_{d} compounds. The technique is illustrated by concrete examples regarding compounds in which M is Ni, Fe, Co, Mn, (MnMg), (FeZn), or (FeCo). These compounds are prepared, via a ceramic route, from LiF precursor of Li and from the sulphate of the M element or elements. Among these compounds, the most advantageous are the compounds that contain Fe, since besides their relatively low cost, they are capable, on the basis of structural and chemical considerations (especially the ionocovalence of the bonds), of exhibiting advantageous electrochemical properties over a range of potential that is desirable for guaranteeing a reliable use for large-volume applications. For reasons of inductive effect, the sulphates should have higher potentials than the phosphates, regardless of their structure. Examples for preparing compounds containing various metallic elements are described, but no electrochemical property is reported. Thus, Example 2 describes the preparation of an LiFeSO₄F compound via a ceramic method at 600° C. which gives a non-homogenous compound, then 500° C. where the compound is red/black, or else at 400° C. in air where the compound is red. This method is capable of enabling the reduction of the SO₄²⁻ group by Fe ²⁺ in the absence of oxygen according to: SO₄²⁻+Fe²⁺SO₂+2O²⁻2Fe³⁺. The red colour observed in the compounds obtained at the various temperatures is due to the O²⁺/Fe³⁺ association in a crystal lattice such as the oxide Fe₂O₃. It is furthermore known that the compounds of Fe^{II} oxidize in air from 200° C. giving Fe^{III}, and the preparation of Example 2 at 400° C. in air confirms it. The compounds containing iron that are prepared via a ceramic route starting from LIF and iron sulphate according to US-2005/0163699 do not therefore consist of LiFeSO₄F. Similarly, it appears that the compounds in which M is Co or Ni are not stable at the temperatures used during the recommended preparation via a ceramic route. It is not therefore plausible that the compounds described in US-2005/0163699 have really been obtained.

International application WO 2010/046608 describes the preparation, via an ionothermal route, of various polyanionic fluorinated compounds of alkali metal (Li or Na) and of transition metal, said compounds being of use as an electrode active material. Among these compounds, those in which the transition metal is Fe are particularly interesting, due to the great abundance of sources and the non-toxicity of Fe, in particular LiFeSO₄F with a favorite structure, NaFeSO₄F, LiFePO₄, LiFePO₄F, LiFePO₄ Na₂Fe_{0.95}Mn_{0.05}PO₄F and LiFe_{1-y}Mn_{y}SO₄F.

M. Ati, et al. [Electrochemistry Communications 13, (2011) 1280-1283] describe the preparation of a pure compound of formula LiFeSO₄F with a triplite structure.

Other iron sulphates, but this time that are not fluorinated, have previously been reported as positive electrode active materials. Several groups, including Okada et al, [Proceedings of the 36th International Power Sources Symposium, (1994) 110-113], Takacs et al. [Hyperfine interactions 40, (1988) 347-350] and Arai et al. [patent application EP 0743692] have shown that it was possible to reversibly insert lithium into Fe₂(SO₄)₃ by reduction of this material via an electrochemical route or via a chemical route. However, the direct synthesis of LiₓFe₂(SO₄)₃ has never been reported,

U.S. Pat. No. 5,908,716 describes compounds based on sulphate and on at least one transition metal, and also the use thereof as positive electrode active material. These compounds correspond to the formula AₓM_{y}(SO₄)_{z} in which x, y and z are >0, A is chosen from alkali metals, M represents a metal, preferably a transition metal. The iron-based compounds specifically mentioned in this document are the following: Li₃Fe(SO₄)₃, Li₁Fe₁(SO₄)₂, Na₃Fe(SO₄)₃, and also the intermediate compositions Liₓ₁NaNₓ₂V_{y1}Fe_{y2}(SO₄)₂ and Liₓ₁Naₓ₂V_{y1}Fe_{y2}(SO₄)₃. U.S. Pat. No. 5,908,716 does not however report any structural characterization of these compounds, or any electrochemical data, which does not make it possible to prove whether these materials have actually been obtained. Moreover, all of the Fe-based materials proposed as examples contain iron in the +III oxidation state, and cannot therefore be oxidized in order to serve as a source of lithium, contrary to what is indicated in U.S. Pat. No. 5,908,716.

However, in practice, the technologies of Li-ion or Na-ion batteries are initially assembled in the discharged state, that is to say by using an active material at the negative electrode that cannot initially release alkali metal ions (e.g. electrodes based on graphite, amorphous carbon, Li₄Ti₅O₁₂, etc). The active material at the positive electrode must consequently be the source material for alkali metal ions, that is to say that it must be capable of releasing alkali metal ions when it is oxidized. In the case of an iron-based compound, the chemical formula of a positive electrode material must therefore initially contain lithium atoms in its structure and also iron atoms in the +II oxidation state. However, it turns out that iron in the +II oxidation state oxidizes very easily to iron +III. Compounds based on iron +III are indeed very stable compounds. It is therefore more difficult to stabilize phases based on iron +II than phases based on iron +III. For that, it is necessary to work under very particular conditions that are difficult to implement, for example in an acid medium or in a reducing medium.

Moreover, an important criterion for selecting a compound as a cathode active material for a battery operating by circulation of alkali metal (Li or Na) ions is a high operating potential. Among the compounds containing Fe as a transition metal, the reported operating potentials are 3.4 V vs. Li⁰/Li⁺ for LiFePO₄, 3.6 V vs. Li⁰/Li⁺ for Fe₂(SO₄)₃, 3.6 V vs. Li⁰/Li⁺ for LiFeSO₄F with tavorite structure, and 3.9V vs. Li⁰/Li⁺ for LiFeSO₄F with triplite structure.

It is acknowledged in the technical field that the operating potential of an electrode containing a polyanionic compound increases with the electronegativity of the anionic group. These observations are explained by the concepts of ionocovalence and inductive effect (cf. in particular Padhi, A. K., et al. [J. Electrochem. Soc. 144, 2581-2586 (1997)] and Padhi, A. K., et al. [J. Electrochem. Soc. 145, 1518-1520 (1998)]). Thus, it is expected for example that (i) a material containing sulphates will have a higher electrochemical potential than an analogous material containing phosphates, (ii) a material containing two (SO₄)²⁻ groups will have a higher electrochemical potential than an analogous material containing only one sulphate group, (iii) a material containing an (SO₄)²⁻ group and an F⁻ anion will have a higher electrochemical potential than an analogous material containing two (SO₄)²⁻ groups.

However, the inventors have been able to stabilize polyanionic compounds based on sulphate, iron in the +II oxidation state arid alkali metal, and which, surprisingly, make it possible to achieve high potentials, even though they do not contain fluorine, which can pose safety problems both in production and in the use of electrochemical devices.

The objective of the present invention is to provide a novel electrode material containing alkali metals and iron in the +II oxidation state, which is free of fluorine and which nevertheless has a high operating potential, and also a process which makes it possible to produce said material in a reliable, rapid and economic manner.

An electrode material according to the present invention is characterized in that it contains, as positive electrode active material, at least one sulphate of iron in the +II oxidation state and of alkali metal corresponding to the formula (Na₁₋ₐLi_{b})ₓFe_{y}(SO₄)_{z} in which the subscripts a, b, x, y and z are chosen so as to ensure the electroneutrality of the compound, with 0≦a≦1, 0≦b≦1, 1≦x≦3, 1≦y≦2, 1≦z≦3, and 2≦(2z−x)/y<3 so that at least one portion of the iron is in the +II oxidation state, with the exclusion of the compound Li₂Fe₂(SO₄)₃, the use of which as a positive electrode active material has already been described, in particular in patent application EP 0 743 692.

Excluded from the subject of the present invention are the compounds of formula (I) that do not contain iron in the +II oxidation state (i.e. for which (2z−x)/y=3), such as for example NaFe(SO₄)₂ and Na₃Fe(SO₄)₃.

An electrode material of the invention preferably contains at least 50% by weight of compound of formula (I), more preferably at least 80% by weight.

In one particularly preferred embodiment, the electrode material also contains an electron-conducting agent, and optionally a binder.

The proportion of electron-conducting agent is preferably less than 15% by weight.

The proportion of binder is preferably less than 10%.

The sulphates of formula (1) used as active material in an electrode material according to the invention are novel, with the exception of the compound Li₂Fe₂(SO₄)₃, which has however never been obtained by direct synthesis (i.e.

other than by reduction of the compound Fe₂(SO₄)₃). in this respect they constitute another subject of the invention.

Among the sulphates of formula (I) above, and that are particularly advantageous as active material of an electrode material of the present invention, mention may in particular be made of Li₂Fe(SO₄)₂, Na₂Fe(SO₄)₂, and the mixed sulphates of formula (I′) (Na₁₋ₐLi_{b})Fe(SO₄)₂ in which 1≦x≦3 and with 0<a<1 and 0<b<1.

The compound Li₂Fe(SO₄)₂ crystallizes in the monoclinic system (P2₁/c space group). Its lattice parameters are: a=4.9871(1) Å, b=8.2043(1) Å, c=8.8274(1) Å, β=121,748(1)°.

The compound Na₂Fe(SO₄)₂ crystallizes in the P2₁/n system. Its lattice parameters are a=8.9511(7) Å, b=10.3745(7) Å, c=15.0776(9) Å, β=90.390(7)°, V=1400.1(2) Å³.

A sulphate of formula (I) according to the present invention can be prepared via a ceramic route, from sulphate precursors, in particular from lithium sulphate, sodium sulphate and iron sulphate. The precursors are mixed using amounts that correspond to the stoichiometry of the sulphate of formula (I). The precursors may be mixed for example in a mill in order to promote intimate contact between the precursors. The mixture is then subjected to a heat treatment at a temperature between 100° C. and 350° C. Since the sulphate of formula (I) contains iron in the +II oxidation state, the heat treatment must be carried out in an inert or reducing atmosphere in order to prevent the oxidation of Fe^{II+} to Fe^{III+}. The synthesis may for example be carried out under vacuum or in an inert gas (for example argon) atmosphere.

A sulphate of formula (I) according to the present invention may also be prepared via an ionothermal route, from the same sulphate precursors as those mentioned for the ceramic route, in particular from lithium sulphate, sodium sulphate and iron sulphate. The precursors are mixed, using amounts that correspond to the stoichiometry of the sulphate of formula (I). The mixture of precursors is then dispersed in an ionic liquid. The suspension thus formed is introduced into a reactor, in which it is subjected to a heat treatment for several hours at a temperature above 100° C. The maximum temperature is determined by the stability of the ionic liquid used (for example by its decomposition temperature).

The expression “ionic liquid” is understood to mean a compound that contains only anions and. cations, the charges of which are balanced, and which is liquid at the temperature of the reaction for formation of the compounds of the invention, either pure, or as a mixture with an additive. The use of an ionic liquid constitutes an inert reaction medium, which prevents the oxidation of iron +II. As ionic liquid that can be used for the preparation of sulphates of formula (I), 1-ethyl-3-methylimidazollum bis(trifluoromethanesulphonyl)imide (EMI-TFSI) is very particularly preferred.

A sulphate of formula (I) according to the present invention may also be prepared via a “flash sintering” route, also known by the name SPS which is the acronym for the expression “Spark Plasma Sintering”, from the same sulphate precursors as those mentioned for the ceramic route, in particular from lithium sulphate, sodium sulphate and iron sulphate. The precursors are mixed, using amounts that correspond to the stoichiometry of the sulphate of formula (I). The mixture of sulphate precursors is then placed in a carbon die in a flash sintering (SPS) apparatus and the mixture is subjected to a rapid heating at temperatures between 100° C. and 400° C. for a duration of a few minutes to a few hours while it is pressed at a pressure greater than 1 bar.

Irrespective of the chosen synthesis route, the sulphate precursors may be hydrated sulphates or anhydrous sulphates. Anhydrous sulphates are obtained by simple heat treatment of commercial hydrated sulphates up to the dehydration temperature specific to each of them.

A sulphate of formula (I) in which at least one portion of the iron is in the Fe^{III+} state may also be obtained by chemical or electrochemical oxidation of the analogous sulphate containing only Fe^{II+} according to the general reaction:

(Na₁₋ₐLi_{b})ₓFe^{II+}_{y}(SO₄)_{z}+oxidizer→(Na₁₋ₐLi_{b})ₓ₋₁Fe^{III+}_{y1}Fe^{II+}₂(SO₄)_{z} in which the subscripts a, b, x, y and z are as defined previously and y=y1+y2.

Among the suitable oxidizing agents, mention may in particular be made of NO₂BF₄.

The compound Li₂Fe^{II+}(SO₄)₂ is preferably prepared from anhydrous Li₂SO₄ and anhydrous FeSO₄. The anhydrous sulphates are obtained from the commercial products FeSO₄.7H₂O and Li₂SO₄.H₂O. The two precursors, whether anhydrous or not, are mixed in an inert atmosphere using amounts that correspond to the stoichiometry of the final material. The mixture is then placed in an inert atmosphere, then subjected to a heat treatment at a temperature between 200° C. and 350° C. The precursors may be mixed using a mill of SPEX type, for example for two periods of 30 minutes. The inert atmosphere may be an argon atmosphere or a chamber under low vacuum. The chamber under low vacuum may be a quartz or Pyrex® flask. The heat treatment is carried out at a temperature preferably above 300° C. The duration of the heat treatment is preferably greater than 12 hours. The mixture of precursors subjected to the heat treatment may be shaped into pellets, which promotes contact between the precursors, the chance for the species to migrate and also the obtaining of a complete reaction and of pure products.

The compound Na₂Fe^{II+}(SO₄)₂ can be prepared from Na₂SO₄ and FeSO₄.7H₂O. The precursors, in stoichiometric amounts, are mixed in an inert atmosphere. The mixture is then placed in an inert atmosphere, then subjected to a heat treatment at a temperature between 140° C. and 300° C. The inert atmosphere may be nitrogen or argon for example. The heat treatment may be carried out directly on the mixture of precursors in powder form. The precursors may be mixed by mechanical milling, for example using a mill of SPEX type for 20 minutes. The precursors may also be mixed by dissolving the precursors in water and evaporating between 20° C. and 100° C. while stirring. In this embodiment, it is preferable to work under anoxic conditions, in order to prevent the oxidation of Fe^{II+} to Fe^{III+}.

A sulphate of formula (Na₁₋ₐLi_{b})ₓ(SO₄)_{z} (I) can be obtained via an electrochemical route from a sulphate of formula Naₓ.Fe_{y}(SO₄), in which y and z are as defined previously for the sulphates of formula (I) and with 1≦x′≦3, corresponding to the formula (I) in which a=) and b=0. The process is carried out in an electrochemical cell in which the active material of the positive electrode is the compound Na^{x′}Fe_{y}(SO₄)_{z}, the anode is an anode that contains lithium, and the electrolyte contains a lithium salt. The electrochemical cell is subjected to a charge/discharge cycle in the appropriate potential range, for example between 2.0 and 4.2 V vs. Li⁺/Li°. During the cycling, Na⁺ ions are extracted and Li⁺ ions are inserted into the host compound Na_{x′}Fe_{y}(SO₄)_{z} and the formula of the sulphate obtained is Na_{z′-T}Li_{T′}Fe_{y}(SO₄)_{z} (avec 0≦T>x′ and 0≦T′≦x′) which may also be written in the form: (Na_{1-T/x′}Li_{T′/x′})_{x′}Fe_{y}(SO₄), where a=T/x′, b=T′/x′ and x=x′). This electrochemical route is particularly advantageous for attaining the mixed sulphates of formula (I′) (Na₁₋ₐLi_{b})ₓFe(SO₄)₂ as described above.

A sulphate of formula (Na₁₋ₐLi_{b})ₓFe_{y}(SO₄)_{z} (I) may be obtained via an electrochemical route starting from a sulphate of formula Li_{x′}Fe_{y}(SO₄)_{z} corresponding to the formula (I) in which y and z are as defined previously for the sulphates of formula (I) and with 1≦x′≦3, corresponding to the formula (I) with a=1 and b=1. The process is carried out in an electrochemical cell in which the active material of the positive electrode is the compound LiFe_{x′}(SO₄)₇, the anode is an anode that contains sodium, and the electrolyte contains a sodium salt. The electrochemical cell is subjected to a charge/discharge cycle in the appropriate potential range, for example between 2.8 and 4.5V vs. Na⁺/Na°. During the cycling Li⁺ ions are extracted and Na⁺ ions are inserted into the host compound Li_{x′}Fe_{y}(SO₄)_{z} and the formula of the sulphate obtained is Na_{T}Li_{z′-T′)Fe}_{y}(SO₄)_{z}, (with 0≦T≦x′ and 0≦T′≦x′) (which may also be written in the form: (Na_{1-(1-T)}Li^{x′-T′})Fe_{y}(SO₄), where a′=a*x=1−T and b′=b*x=x′−T′). This electrochemical route is particularly advantageous for attaining the mixed sulphates of formula (I′) (Na₁₋ₐLi_{b})ₓFe(SO₄)2 as described above.

An electrode material containing the compound (I) according to the invention may be used in various electrochemical devices. By way of example, an electrode material of the invention may be used for the manufacture of electrodes in electrochemical devices that operate by circulation of alkali metal ions (Li⁺ or Na⁺) in the electrolyte, such as in particular batteries, supercapacitors and electrochromic systems.

An electrode containing an electrode material according to the invention may be prepared by depositing a positive electrode composition containing a sulphate of formula (I) onto a current collector, Said composition preferably also contains an electron-conducting agent, and optionally a binder. The content of sulphate in said composition is preferably at least equal to 50% by weight, more preferably at least equal to 80% by weight. The content of electron-conducting agent is less than 15% by weight, and the content of binder is less than 10%.

Said electrode composition is obtained by mixing the constituents in the appropriate proportions. The mixing may be carried out in particular by mechanical milling.

The electron-conducting agent may be for example a carbon black, an acetylene black, natural or synthetic graphite or carbon nanotubes.

The optional binder of the positive electrode is preferably a polymer which has a high modulus of elasticity (of the order of several hundred MPa), and which is stable under the temperature and voltage conditions in which the electrode is intended to operate. By way of examples, mention may be made of fluoropolymers (such as a polyvinyl fluoride or a polyethylene tetrafluoride), carboxymethyl celluloses (CMC), copolymers of ethylene and propylene, or a blend of at least two of these polymers.

When the material of the working electrode contains a polymer binder, it is advantageous to prepare a composition containing the sulphate of formula (I), the binder, a volatile solvent, and optionally an ion-conducting agent, to apply said composition to a current collector, and to eliminate the volatile solvent by drying. The volatile solvent may be chosen, for example, from acetone, tetrahydrofuran, diethyl ether, hexane and N-methylpyrrolidone.

The amount of material deposited on the current collector is preferably such that the amount of compound according to the invention is between 0.1 and 200 mg per cm², preferably from 1 to 50 mg per cm². The current collector may consist of a grid or foil of aluminium, of titanium, of graphite paper or of stainless steel.

An electrode according to the invention may be used in an electrochemical cell comprising a positive electrode and a negative electrode separated by an electrolyte. The electrode according to the invention forms the positive electrode.

The negative electrode may consist of metallic lithium or a lithium alloy, metallic sodium or a sodium alloy or a transition metal oxide that forms, via reduction, a nanoscale dispersion in lithium oxide, or a double nitride of lithium and of a transition metal.

The negative electrode may also consist of a material capable of reversibly inserting Li⁺ ions at potentials lower than that of the positive electrode, preferably lower than 1.6 V.

As examples of such materials, mention may be made of low-potential oxides that have the general formula Li_{1+y+x/3}Ti_{2-x/3}O₄ (0≦x≦1, 0≦y≦1), Li_{4+x′}Ti₅O₁₂ (0≦x′≦3), carbon and carbon-based products resulting from the pyrolysis of organic materials, and also dicarboxylates.

As examples of elements that can form alloys with lithium, mention may be made, for example, of Sn and Si. As an example of elements that can form alloys with sodium, mention may be made, for example, of Pb.

The electrolyte advantageously comprises at least one lithium or sodium salt in solution in a polar aprotic liquid solvent, in a solvating polymer optionally plasticized by a liquid solvent or an ionic liquid, or in a gel consisting of a liquid solvent gelled by addition of a solvating or non-solvating polymer.

The salt of the electrolyte may be chosen from the salts conventionally used in the technical field, in particular the salts of strong acids, such as for example the salts having a ClO₄⁻, BF₄⁻ or PF₆⁻ anion, and the salts having a perfluoroalkanesulphonate, bis(perfluoroalkylstilphonyl)imide, bis(perfluoroalkyl-sulphonyl)methane or tris(perfluoroalkylsulphonyl)methane anion.

When the negative electrode is lithium or a lithium ion insertion compound, the salt of the electrolyte is a lithium salt. LiClO₄ is particularly preferred.

When the negative electrode is sodium or a sodium ion insertion compound, the salt of the electrolyte is a sodium salt. NaClO₄ is particularly preferred.

When the electrolyte is a liquid electrolyte, the liquid solvent is preferably a polar aprotic liquid organic solvent chosen for example from linear ethers and cyclic ethers, esters, nitrites, nitrogen-containing derivatives, amides, sulphones, sulpholanes, alkylsulphamides and partially hydrogenated hydrocarbons. These solvents that are particularly preferred are diethyl ether, dimethoxyethane, glyme, tetrahydrofuran, dioxane, dimethyltetrahydrofuran, methyl or ethyl formate, propylene or ethylene carbonate, alkyl carbonates (especially dimethyl carbonate, diethyl carbonate and methyl propyl carbonate), butyrolactones, acetonitrile, benzonitrile, nitromethane, nitrobenzene, dimethylformamide, diethylformamide, N-methylpyrrolidone, dimethyl sulphone, tetramethylene sulphone, and tetraalkylsulphonamides having from 5 to 10 carbon atoms.

When the electrolyte is a polar polymer solvent, it may be chosen from crosslinked or uncrosslinked solvating polymers, which may or may not bear grafted ionic groups. A solvating polymer is a polymer that comprises solvating units containing at least one heteroatom chosen from sulphur, oxygen, nitrogen and fluorine. By way of example of solvating polymers, mention may be made of polyethers having a linear, comb or block structure, which may or may not form a network, based on polyethylene oxide, or copolymers containing the ethylene oxide or propylene oxide or allyl glycidyl ether unit, polyphosphazenes, crosslinked networks based on polyethylene glycol crosslinked by isocyanates or the networks obtained by polycondensation and that bear groups that enable the incorporation of crosslinkable groups. Mention may also be made of block copolymers in which some blocks bear functions that have redox properties. Of course, the above list is not limiting, and all polymers having solvating properties can be used.

The solvent of the electrolyte may simultaneously comprise an aprotic liquid solvent chosen from the aprotic liquid solvents mentioned above and a polar polymer solvent comprising units that contain at least one heteroatom chosen from sulphur, nitrogen, oxygen and fluorine. By way of example of such a polar polymer, mention may be made of the polymers that mainly contain units derived from acrylonitrile, vinylidene fluoride, N-vinylpyrrolidone or methyl methacrylate. The proportion of aprotic liquid in the solvent may vary from 2% (corresponding to a plasticized solvent) to 98% (corresponding to a gelled solvent).

The present invention is illustrated by the following exemplary embodiments, to which it is not however limited.

### EXAMPLE 1

### Preparation of Li₂Fe(SO₄)₂ via a Ceramic Route

The synthesis was carried out using an anhydrous lithium sulphate and an anhydrous Fe sulphate.

The anhydrous iron sulphate FeSO₄ was obtained by heating, under low vacuum and at 280° C., the compound FeSO₄.H₂O, itself prepared by dehydration of the commercial compound FeSO₄.7H₂O in an EMI-TFSI ionic liquid at 160° C.

The anhydrous lithium sulphate Li₂SO₄ was obtained by heating the commercial compound Li₂SO₄.H₂O in air at 300° C.

Equimolar amounts of Li₂SO₄ and FeSO₄ were mixed and the mixture was subjected to two successive 30 minute millings in a SPEX® mill. The mixture of powders thus obtained was then pelleted using a uniaxial press. The pellet was then introduced into a quartz flask, which was sealed under vacuum. The flask was then placed in a furnace and subjected to a heat treatment at 320° C. for 12 hours.

### EXAMPLE 2

### Preparation of Li₂Fe(SO₄)₂ via an Ionothermal Route

The synthesis was carried out using a lithium sulphate hydrate and an Fe sulphate monohydrate.

The iron sulphate monohydrate FeSO₄.H₂O was obtained by mixing the commercial compound FeSO₄.7H₂O with the EMI-TFSI ionic liquid, and by bringing this suspension to 140° C. for 2 hours. The iron sulphate monohydrate FeSO₄.H₂O was then recovered by centrifugation of the suspension, then washed three times with ethyl acetate before being dried under vacuum.

The anhydrous lithium sulphate Li₂SO₄.H₂O is a commercial compound.

Equimolar amounts of Li₂SO₄.H₂O and FeSO₄.H₂O were mixed and the mixture was subjected to a 20 minute milling in a SPEX® mill. The mixture of powders thus obtained was then submerged by EMI-TFSI ionic liquid in a Parr® bomb calorimeter that was sealed under air. The reactor was placed in a furnace and brought to 300° C. for 12 hours.

### EXAMPLE 3

### Preparation of Li₂Fe(SO₄)₂ by “Flash Sintering”(SPS)

The synthesis via the SPS route was carried out by using an anhydrous lithium sulphate and an anhydrous iron sulphate.

The iron sulphate monohydrate FeSO₄.H₂O was obtained by mixing the commercial compound FeSO₄.7H₂O with the EMI-TFSI ionic liquid, and by bringing this suspension to 140° C. for 2 hours. The iron sulphate monohydrate FeSO₄.H₂O was then recovered by centrifugation of the suspension, then washed three times with ethyl acetate before being dried under vacuum. This iron sulphate monohydrate FeSO₄.H₂O was then dehydrated by heating the powder to 280° C. for 8 hours under low vacuum in order to obtain the anhydrous iron sulphate FeSO₄.

The anhydrous lithium sulphate Li₂SO₄ was prepared by heating the commercial lithium sulphate monohydrate at 350° C. for 5 hours.

Equimolar amounts of Li₂SO₄ and FeSO₄ were mixed and the mixture was subjected to three successive 45 minute millings in a SPEX® mill. Around 300 mg of this mixture was then introduced into a carbon die (Mersen 2333) having an internal diameter of 10 mm, between two carbon foils (Papyex®). The whole assembly was then installed in an HPD 10 FCT SPS machine connected to a glovebox under argon. The powder was then pressed at 50 MPa and was subjected to a 20 minute heat treatment at 320° C. (heating rate 75° C./min via a sequence of 1 pulse of 1 ms in continuous polarization) under vacuum.

### EXAMPLE 4

### X-Ray Diffraction Characterization of Li₂Fe(SO₄)₂ Obtained via a Ceramic Route

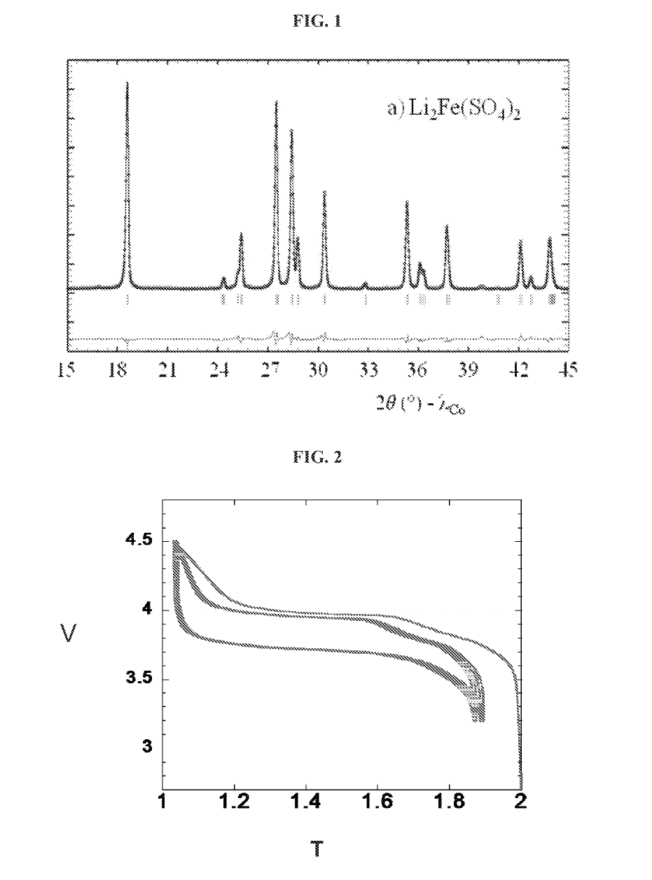

The compound obtained in Example 1 above was characterized by x-ray diffraction (XRD) with cobalt Kα radiation. The diffraction pattern is represented in appended FIG. 1.

The structure of the Li₂Fe(SO₄)₂ phase was resolved and FIG. 1 shows the Rietveld refinement of the XRD pattern recorded for the sample prepared in Example 1.

### EXAMPLE 5

### Electrochemical Activity of Li₂Fe(SO₄)₂ Obtained via a Ceramic Route

The compound Li₂Fe(SO₄), from Example 1 above was tested as a positive electrode material in a Swagelok® cell in which the negative electrode is a lithium film, and the two electrodes are separated by a glass fibre separator soaked with a 1M solution of LiClO₄ in propylene carbonate PC. For the production of a positive electrode, 100 mg of compound Li₂Fe(SO₄)₂ and 25 mg of Super P® carbon were mixed by mechanical milling in a SPEX 8000® mill for 19 minutes. An amount of the mixture corresponding to 8 mg of Li₂Fe(SO₄)₂ per cm² was applied to a. stainless steel current collector.

The electrochemical cell was cycled between 3.2 and 4.5 V vs. Li⁺/Li° under a C/20 regime.

The appended FIG. 2 represents the variation of the potential V (in volts vs. Li⁺/Li°) as a function of the degree of insertion T of the lithium into Li_{T}Fe(SO₄)₂, during the cycling of the cell under a C/20 regime.

The appended FIG. 3 represents the derivative curve dT/dV=f(V), V being in volts vs. Li⁺/Li° on the x-axis.

FIGS. 2 and 3 show that the potential of the Fe³⁺/Fe²⁺ pair in Li₂Fe(SO₄)₂ is 3.83 V vs. This potential is larger than the potential of the compound LiFe(SO₄)F of tavorite structure (for which the potential of the Fe³⁺/Fe²⁺ pair is equal to 3.6 V vs. Li⁺/Li°) even though Li₂Fe(SO₄)₂ does not contain fluorine. Furthermore, this potential of 3.83 V vs. Li⁺/Li° corresponds to the highest potential ever reported for the Fe²⁺/Fe³⁺ redox pair in an inorganic compound that does not contain fluorine.

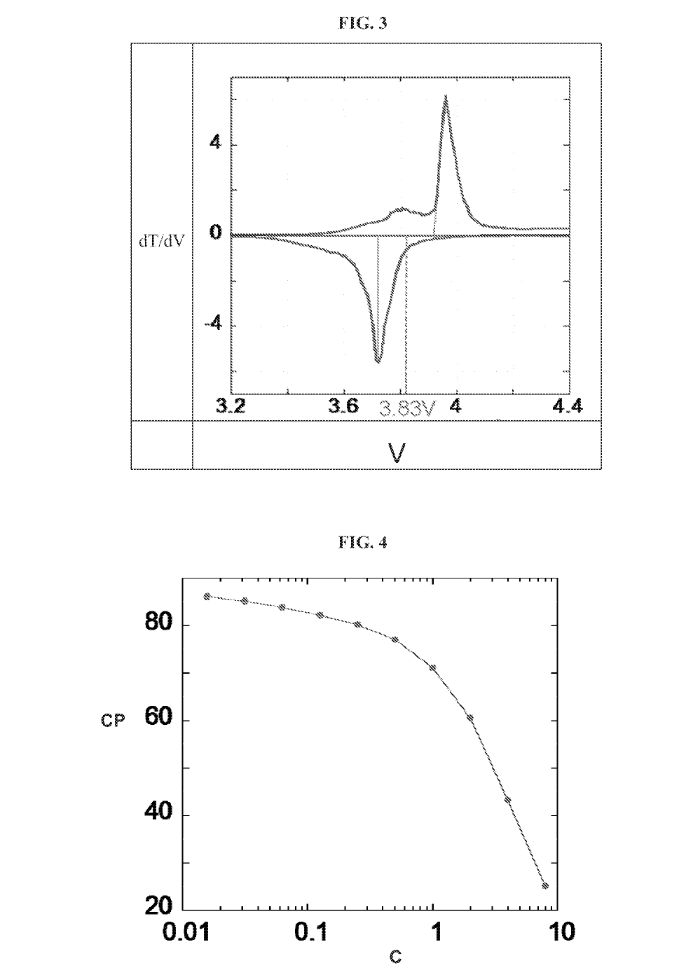

The appended FIG. 4 represents the variation of the capacitance CP (mAh/g) as a function of the cycling regime C, an n C regime representing the regime that makes it possible to achieve a complete charge in 1/n hour.

From FIG. 4, it is deduced that a slow charge/discharge process favours maintenance of the capacitance.

### EXAMPLE 6

### X-Ray Diffraction Characterization of Li₂Fe(SO₄)₂ Obtained by an SPS Route

The compound obtained above in Example 3 was characterized by x-ray diffraction (XRD) with cobalt Ku. radiation. The diffraction pattern is represented s in appended FIG. 5.

The appended FIG. 5 shows the Rietveld refinement of the XRD pattern recorded for the sample prepared in Example 3. The star indicates a diffraction line attributed to graphite originating from the graphite die used for the synthesis; the hash sign (ft) indicates a very small amount of FeSO₄ precursor that is not completely reacted.

Comparison of FIG. 5 with FIG. 1 clearly shows that the same Li₂Fe(SO₄)₂ phase is obtained by the SPS route as that prepared by the ceramic route.

### EXAMPLE 7

### Electrochemical Activity of Li₂Fe(SO₄)₂ Obtained by an SPS Route

The compound Li₂Fe(SO₄)₂ from Example 3 above was tested as a positive electrode material in a Swagelok® cell in which the negative electrode is a lithium film, and the two electrodes are separated by a glass fibre separator soaked with a 1M solution of LiClO₄ in propylene carbonate PC. For the production of a positive electrode, 100 mg of compound Li₂Fe(SO₄)₂ and 25 mg of Super P® carbon were mixed by mechanical milling in a SPEX 8000 mill for 20 minutes. An amount of the mixture corresponding to 8 mg of Li₂Fe(SO₄)2 per cm² was applied to a stainless steel current collector.

The electrochemical cell was cycled between 2.8 and 4.5 V vs. Li⁺/Li° under a C/20 regime.

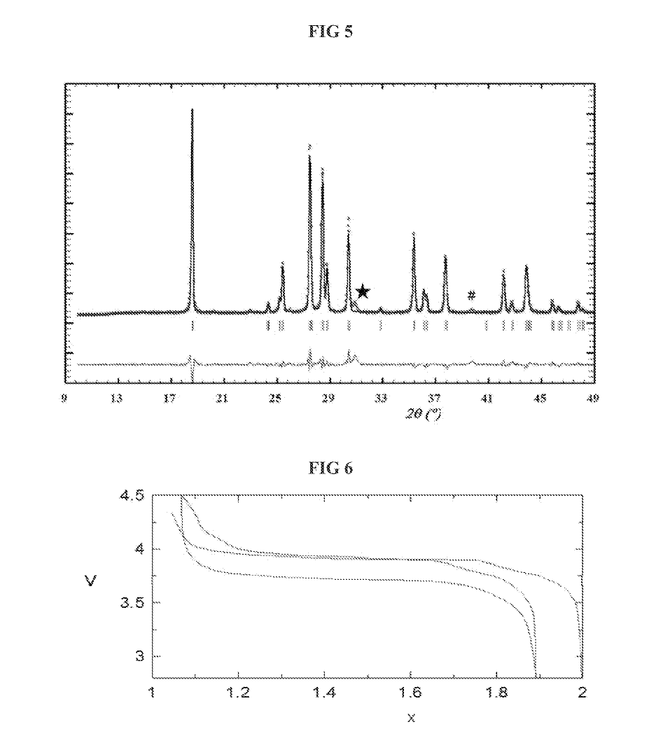

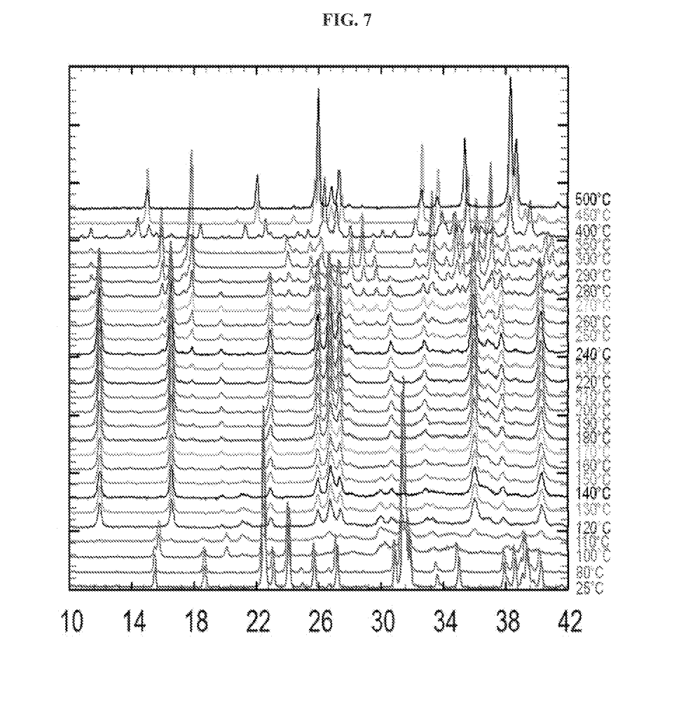

The appended FIG. 6 represents the variation of the potential V (in volts vs. as a function of the degree of insertion x of the lithium into LiₓFe(SO₄)₂, during the cycling of the cell under a C/20 regime.

FIG. 6, compared to FIG. 2, shows that the same electrochemical behaviour is obtained for the compound Li₂Fe(SO₄)₂ prepared by the SPS route or prepared by the ceramic route, with however a slightly smaller polarization in the case of Li₂Fe(SO₄)₂ prepared by the SPS route.

### EXAMPLE 8

### Preparation of Na₂Fe(SO₄)₂ via a Ceramic Route

The synthesis was carried out using an anhydrous sodium sulphate Na₂SO₄ and a commercial iron sulphate FeSO₄.7H₂O.

Equimolar amounts of Na₂SO₄ and FeSO₄.7H₂O were mixed and the mixture was subjected to a 20 minute milling in a SPEX8000® mill. The compound Na₂Fe(SO₄)₂.4H₂O was thus obtained in the form of a powder.

Said powder was subjected to a heat treatment under a stream of nitrogen up to a temperature of 500° C. During the heat treatment, the formation of the compound Na₂Fe(SO₄) ₂ was monitored by XRD with a wavelength λ=1.79 Å. The change in the curves is represented on the appended FIG. 7. The x-axis corresponding to the angle 2θ expressed in degrees.

FIG. 7 shows that the compound Na₂Fe(SO₄)₂ is formed starting from 120° C. in an allotropic a form. This α phase is perfectly stable up to 180° C., at which temperature the appearance of a new group of peaks begins to be observed, which peaks will increase at the expense of the diffraction peaks of the α-Na₂Fe(SO₄)₂ phase up to the temperature of 350° C. This second group of diffraction peaks is characteristic of the β-Na₂Fe(SO4)2 phase. This second β-Na2Fe(SO4)2 phase is stable up to at least 350° C. At 500° C., the XRD pattern recorded highlights the presence of Na₂SO₄ and Fe₂O₃, suggesting the decomposition of Na₂Fe(SO₄)₂ between 350° C. and 500° C.

### EXAMPLE 9

### Preparation of Na₂Fe(SO₄)₂ and X-Ray Diffraction Characterization

A compound Na₂Fe(SO₄)₂ was prepared according to the procedure from Example 8, carrying out the heat treatment at 170° C. for 2 hours.

The compound obtained was characterized by XRD. The appended FIG. 8 represents the pattern obtained. It shows the characteristic peaks of the α-Na₂Fe(SO₄)₂ phase.

### EXAMPLE 10

### Electrochemical Activity of Na₂Fe(SO₄)₂

The compound Na₂Fe(SO₄)₂ from Example 9 above was tested as a positive electrode material in a Swagelok® cell in which the electrode is a film of alkali metal A (lithium or sodium), the two electrodes being separated by a glass fibre separator soaked with a 1M solution of AClO₄ in propylene carbonate (PC). For the production of a positive electrode, 100 mg of compound Na₂Fe(SO₄)₂ and 40 mg of carbon were mixed by mechanical milling in a SPEX 8000® mill for 15 minutes. An amount of the mixture corresponding to 8 mg of sulphate per cm² was applied to a stainless steel current collector.

The cycling was carried out:
with an electrochemical cell in which the anode is sodium under a C/30 regime between 2.0 and 4.2 V vs. Na⁺/Na°;
with an electrochemical cell in which the anode is lithium under a C/30 regime between 2.0 and 4.2 V vs. Li⁺/Li°.

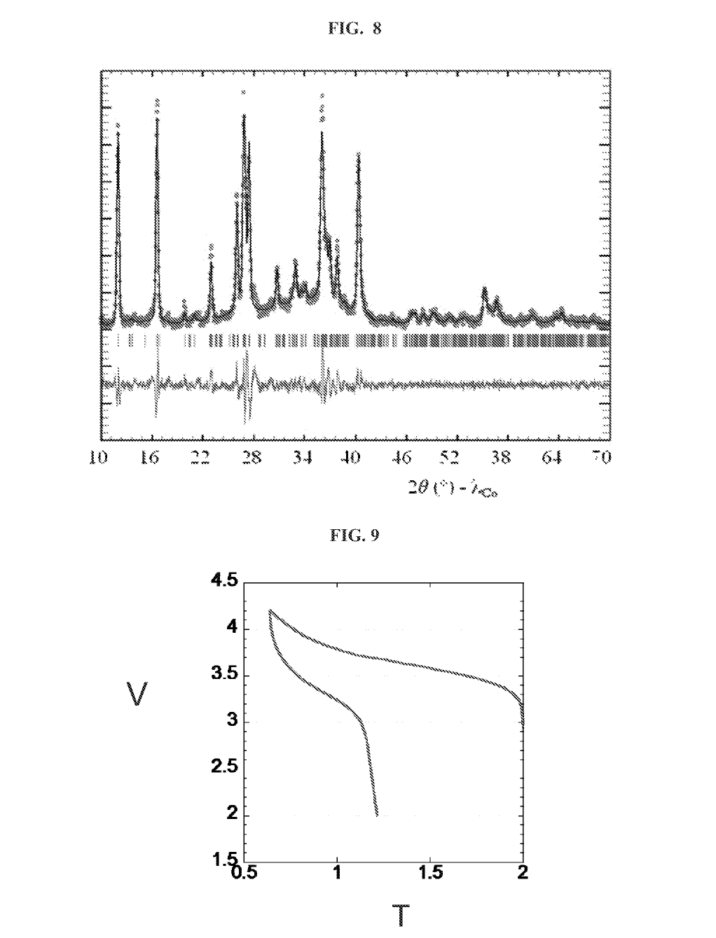

The appended FIG. 9 represents the variation of the potential V (in V vs. Na⁺/Na° as a function of the degree of insertion T of sodium into the compound Na_{T}Fe(SO₄)₂, during the cycling of the cell in which the anode is Na and the electrolyte contains NaClO₄.

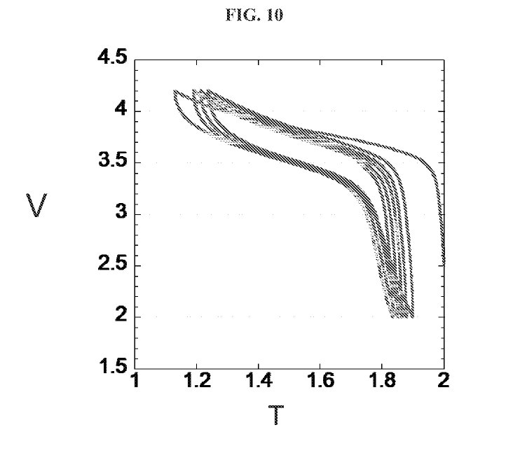

The appended FIG. 10 relates to a cell in Which the anode is lithium and the electrolyte salt is LiClO₄. FIG. 10 represents the variation of the potential V (in V vs. Li⁺/Li°) as a function of the degree of insertion T of the alkali metals Na and Li into A_{T}Fe(SO₄)₂ (A=alkali metals).

During the 1^{st} charge, Na⁺ ions are extracted from the sulphate Na₂Fe(SO₄)₂, in conjunction with the oxidation of Fe^{II+} to Fe^{III+}. The empirical formula of the sulphate observed during this first charge is they Na_{2-a′}Fe(SO₄)₂, with 0≦a′≦1.

During the 1^{st} discharge, Li⁺ ions are inserted into the host compound Na_{2-a′}Fe(SO₄)₂, as a replacement for the Na⁺ ions previously extracted, and the sulphate becomes Na_{2-a′}Li_{b′}Fe(SO₄)₂, with 0≦a′≦1, 0≦b′≦1 and 1≦2−a′+b′≦2.

The first discharge/charge cycle consequently gives rise to a partial replacement of Na by Li. The subsequent cycles then give rise to an extraction/insertion of lithium and/or of sodium in the sulphate forming the active material of the cathode.

It thus appears that a sulphate of Na_{2-a′}Li_{b′}Fe(SO₄)₂ type with 0≦a′≦1 and 0≦b′≦1 (that can also be written in the form (Na₁₋ₐLi_{b})ₓFe(SO₄)₂ (I′)) may be obtained via an electrochemical route from a sulphate of empirical formula Na₂Fe(SO₄)₂ (particular case of the formula (I) where a=0, b=0 and x=2).

1. Positive electrode material, said positive electrode material comprising, as positive electrode active material, at least one sulphate of iron in the +II oxidation state and of alkali metal corresponding to the formula (Na₁₋ₐLi_{b})ₓFe_{y}(SO₄)₂ (I) in which the subscripts a, b, x, y and z are chosen so as to ensure the electroneutrality of the compound, with 0≦a≦1, 0≦b≦1, 1≦x≦3, 1≦y≦2, 1≦z≦3, and 2≦(2z−x)/y<3 so that at least one portion of the iron is in the +II oxidation state, with the exclusion of the compound Li₂Fe₂(SO₄)₃.

2. Material according to claim 1, wherein said material contains at least 50% by weight of sulphate of formula (I).

3. Material according to either of claim 1, wherein said material also contains an electron-conducting agent and a binder.

4. Material according to claim 1, wherein the sulphate of formula (I) is chosen from Li₂Fe(SO₄)₂, Na₂Fe(SO₄)₂, and the mixed sulphates of formula (I′) (Na₁₋ₐLi_{b})ₓFe(SO₄)₂ in which 1≦x≦3 and with 0<a<1 and 0<b<1.

5. Process for preparing an electrode containing an electrode material according to claim 1, wherein said method comprises depositing a positive electrode composition containing a sulphate of formula (I) onto a current collector.

6. Process according to claim 5, wherein said composition also contains an electron-conducting agent and a binder.

7. Process according to claim 6, wherein the content of sulphate in said composition is at least equal to 50% by weight, the content of electron-conducting agent is less than 15% by weight, and the content of binder is less than 10%.

8. Process according to claim 6, wherein the electron-conducting agent is a carbon black, an acetylene black, natural or synthetic graphite or carbon nanotubes.

9. Process according to either of claims 6 and 7, characterized in that the binder is a polymer chosen from fluoropolymers, carboxymethyl celluloses, and copolymers of ethylene and propylene, or a blend of at least two of these polymers.

10. Sulphate of iron in the +II oxidation state and of alkali metal corresponding to the formula (Na₁₋ₐLi_{b})ₓFe_{y}(SO₄)_{z} (I) in which the subscripts a, b, x, y and z are chosen so as to ensure the electroneutrality of the compound, with 0≦a≦1, 0≦b≦1, 1≦x≦3, 1≦y≦2, 1≦z≦3, and 2≦(2z−x)/y<3 so that at least one portion of the iron is in the +II oxidation state, with the exclusion of the compound Li₂Fe₂(SO₄)₃.

11. Iron sulphate according to claim 10, wherein said iron sulfate is chosen from Li₂Fe(SO₄)₂, Na₂Fe(SO₄)₂, and the mixed sulphates of formula (I′) (Na₁₋ₐLi_{b})ₓFe(SO₄)₂ in which 1≦s≦3 and with 0<a<1 and 0<b<1.

12. Process for preparing a sulphate of formula (Na₁₋ₐLi_{b})ₓFe_{y}(SO₄)_{z} (I), in which the subscripts a, b, x, y and z are chosen so as to ensure the electroneutrality of the compound, with 0≦a≦1, 0≦b≦1, 1≦x≦3, 1≦y≦2, 1≦z≦3, and 2≦(2z−x)/y<3 so that at least one portion of the iron is in the +II oxidation state, starting from lithium sulphate, sodium sulphate and iron sulphate, said process comprising the steps of:
a step that consists in includes mixing the sulphate precursors using amounts corresponding to the stoichiometry of the sulphate of formula (I),
a heat treatment of the mixture at a temperature between 100° C. and 350° C., the heat treatment being carried out in an inert or reducing atmosphere.

13. Process for preparing a sulphate of formula (Na₁₋ₐLi_{b})ₓFe_{y}(SO₄)_{z} (I), in which the subscripts a, b, x, y and z are chosen so as to ensure the electroneutrality of the compound, with 0>a≦1, 0≦b≦1, 1≦x≦3, 1≦z≦3, and 2≦(2z−x)/y<3 so that at least one portion of the iron is in the +II oxidation state, starting from lithium sulphate, sodium sulphate and iron sulphate, said process comprising the steps of:
a step that consists in includes mixing the sulphate precursors using amounts corresponding to the stoichiometry of the sulphate of formula (I);
suspending the mixture of sulphates in an ionic liquid;
a heat treatment of the suspension at a temperature between 100° C. and the stability limit temperature of the ionic liquid.

14. Process for preparing a sulphate of formula (Na₁₋ₐLi_{b})ₓFe_{y}(SO₄)_{z} (I), in which the subscripts a, b, x, y and z are chosen so as to ensure the electroneutrality of the compound, with 0≦a≦1, 0≦b≦1, 1≦x≦3, 1≦y≦2, 1≦z≦3, and 2≦(2z−x)/y<3 so that at least one portion of the iron is in the oxidation state, via an electrochemical route starting from a sulphate of formula Na_{x′}Fe_{y}(SO₄)_{z} in which y and z are as defined for the sulphates of formula (I), wherein:
it is carried out in an electrochemical cell in which the active material of the positive electrode is the compound Na^{x′}Fe_{y}(SO₄)_{z}, the anode contains lithium and the electrolyte contains a lithium salt;
the electrochemical cell is subjected to a charge/discharge cycle.

15. Process tor preparing a sulphate of formula (Na₁₋ₐLi_{b})ₓFe_{y}(SO₄)_{z} (I), in which the subscripts a, b, x, y and z are chosen so as to ensure the electroneutrality of the compound, with 0≦a≦1, 0≦b≦1, 1≦x≦3, 1≦z≦3, and 2≦(2z−x)/y≦3 so that at least one portion of the iron is in the +II oxidation state, via an electrochemical route starting from a sulphate of formula Li_{x′}Fe_{y}(SO₄)_{z} in which y and z are as defined for the sulphates of formula (I), wherein:
it is carried out in an electrochemical cell in which the active material of the positive electrode is the compound Li_{x′}Fe_{y}(SO₄)_{z}, the anode contains sodium, and the electrolyte contains a sodium salt;
the electrochemical cell is subjected to a charge/discharge cycle.
